(19) United States
(12) Patent Application Publication
(10) Pub. No.: US 2006/0232082 A1
(43) Pub. Date: Oct. 19, 2006

(54) Leaf crushing, carrying and pouring device

(76) Inventor: Oliver Tiura, Toronto (CA)

Correspondence Address: YOUNG & BASILE, P.C., 3001 WEST BIG BEAVER ROAD, SUITE 624, TROY, MI, 48084, US

(21) Appl. No.: 11/385,508

(22) Filed: Mar. 21, 2006

Related U.S. Application Data
(60) Provisional application No. 60/663,252, filed on Mar. 21, 2005.

(51) Int. Cl. A47J 45/00

(52) U.S. Cl. 294/1.1

(57) ABSTRACT

A leaf crushing, carrying, and pouring device can be used for efficient garden and lawn refuse clean-up and disposal without getting the user dirty. This device comprises a flexible, durable sheet member having first and second sheet sections with inner and outer surfaces. The first and second sections are joined along an inner edge of the sheet sections so that one of the sheet sections is foldable over the other sheet section. Each sheet section has an outer edge opposite its respective inner edge and two opposite end edges. First and second handles are provided on each of the sheet sections for manually grasping the respective sheet section. The first of these handles is adjacent the outer edge of its respective sheet section and the second is adjacent one of the end edges of its respective sheet section. Preferably the sheet member is made of a strong, reinforced fabric or durable plastics sheeting.

### RELATED APPLICATION

This application claims priority to U.S. provisional application serial no. 60/663,252 on Mar. 21, 2005.

### BACKGROUND OF THE INVENTION

This invention relates to carrying and pouring devices for yard trash, leaves and other debris.

In the fall of the year, a substantial task that faces many homeowners and property owners is picking up and disposing of leaves that have fallen on the ground from trees on the property and adjacent properties. The fallen leaves may be intermixed with tree branches and other debris. Another common disposal problem for gardeners is the disposal of cuttings, divots and weeds left over from garden work. One common solution for disposing of leaves and other natural debris is to rake up the leaves and debris into a pile or piles and then place them in large paper or plastic bags intended for transporting and disposing of such material. However, it can be problematic to lift up and place the leaves or other debris in such bags or in a garbage bin or pail.

Recent U.S. Pat. No. 6,758,596 issued Jul. 6, 2004 to McDonough Concepts LLC describes a disposal bag system for facilitating the collection of debris and leaves, this system comprising a sheet member with first and second connectors attached to first and second ends of the sheet member respectively, loops attached to opposing sides of the sheet member, and hooks attached to the second end of the sheet member. In order to close up a sheet member and form a container bag, each hook is engaged with a respective one of the loops when the sides of the sheet member have been folded inwardly over the leaves. The first and second connectors are connected to one another in order to retain the ends of the sheet member in an upward position.

An earlier bag-type container that is intended for collecting and transporting leaves and grass cuttings is that described in U.S. Pat. No. 4,434,829 issued Mar. 6, 1984 to R. L. Barnard. This so called “yard pan” requires a rigid frame covered with a pliable fabric or plastic film contoured to form a portable bag container that can be opened along one side. At one end, the yard pan can lie nearly flat for filling purposes. The frame is a rectangular shaped double sided structure with two rigid primary side or top members supporting the opening edges of the bag and these side members are hinged at the closed end of the bag, typically to another frame member. Handles can be provided for carrying the container or bag.

It is an object of the present invention to provide an improved leaves and debris carrying and pouring device that is simple in its construction and relatively inexpensive to manufacture.

### SUMMARY OF THE INVENTION

According to one aspect of the invention, a leaf crushing, carrying, and pouring device comprises a flexible, durable sheet member having first and second sheet sections both with inner and outer surfaces. The first and second sections are joined along an inner edge of the sheet sections so that one of the sheet sections is foldable over the other sheet section. Each sheet section has an outer edge opposite its respective inner edge and two opposite end edges. The device also has first and second handles on each of the sheet sections for manually grasping the respective sheet section. The first of these handles is adjacent the outer edge of its respective sheet section and the second is adjacent one of the end edges of its respective sheet section. Preferably the sheet member is made of a strong, reinforced fabric or strong composite plastic sheeting.

Further features and advantages will become apparent from the following detail description taken in conjunction with the accompanying drawings.

### BRIEF DESCRIPTION OF THE DRAWINGS

FIG. 1 is a plan or top view of a first embodiment of a leaf crushing, carrying, and pouring device constructed in accordance with the invention;

FIG. 2 is another plan view of the embodiment of FIG. 1, this view showing one of the sheet sections folded over and on top of the other of the sheet sections that form the device;

FIG. 3 is a perspective view showing the leaf crushing, carrying, and pouring device placed on the ground and leaves being raked onto the upper surface of the device;

FIG. 4 is a plan view of a second embodiment of the leaf crushing, carrying, and pouring device, this embodiment being shown in the laid open position;

FIG. 5 is a plan view of the second embodiment with one of the sheet sections being laid over and located on top of the other sheet section;

FIG. 6 is a perspective view illustrating one way of pulling one of the sheet sections of the device utilizing a cord so that it lays on top of leaves or other debris;

FIG. 7 is a perspective view showing how a user's foot can be used to press down on and crush leaves positioned between the two sections of the device;

FIG. 8. is a further perspective view showing how the present leaf crushing and carrying device can be used to transport leaves to a disposal pile or garbage bin while achieving a balance of forces between the sets of handles;

FIG. 9 is a further perspective view illustrating how a person can employ the present device to pour leaves into a garbage bin or garbage pail by moving one set of handles relative to the other set;

FIG. 10 is a detail end view showing one preferred construction for the elongate edge supporting members of the carrying device; and

FIG. 11 is a detail end view showing one preferred construction for a centerline strip connected to the flexible sheet to form a foldline.

### DETAILED DESCRIPTION OF PREFERRED EMBODIMENTS

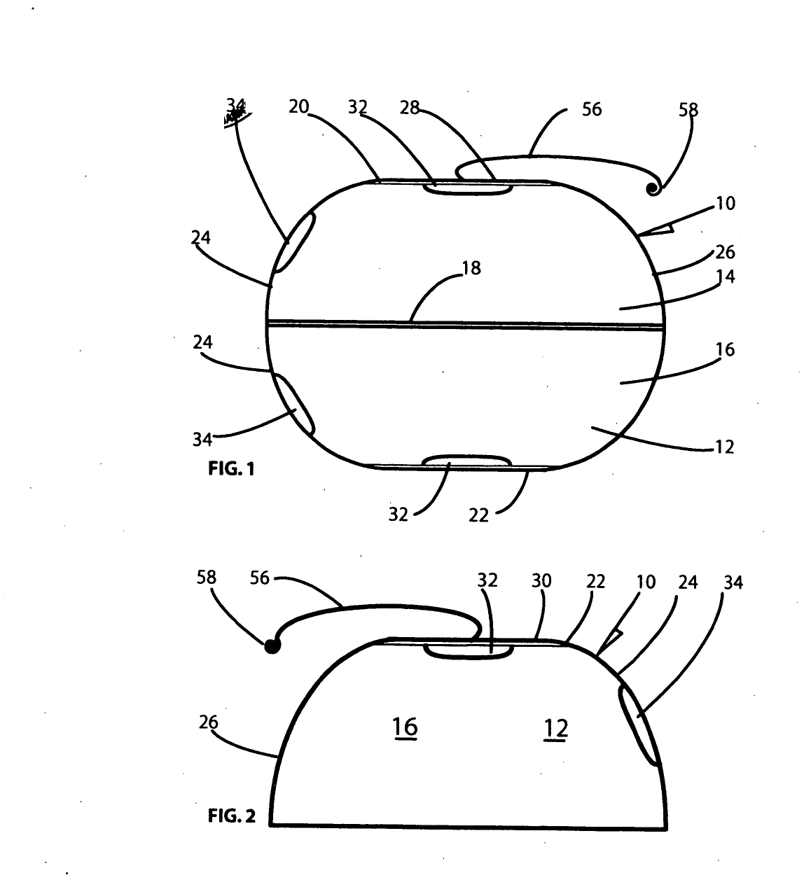

A first preferred embodiment of a leaf crushing, carrying, and pouring device constructed in accordance with the invention is illustrated in FIGS. 1 to 3. This device 10 is hereinafter referred to as a carrying device for sake of brevity but it will be understood that it is also capable of being used to crush leaves and debris and to easily pour such materials as explained further hereinafter.

The preferred device 10 comprises a flexible, durable sheet member 12 having a first sheet section 14 and a second sheet section 16 located on opposite sides of a longitudinal centerline 18. These first and second sections are joined along inner edges of the sheet sections located at the centerline 18. Either one of the sheet sections 14, 16 is foldable over the other sheet section in the manner illustrated in FIG. 2. In FIG. 2, the sheet section 16 is shown laying on top of the underlying sheet section 14 and because the two sheet sections have the same size and shape, the second sheet section 16 completely covers the first sheet section. Each sheet section has an outer edge located at 20, 22 which is opposite its respective inner edge and also has two opposite end edges 24, 26.

Preferably elongate, edge supporting members or rods are provided at the outer edges 20, 22. In FIGS. 1 and 2 these rods 28, 30 are straight and extend the entire length of their respective straight outer edge. One preferred material for these elongate edge support members or rods is carbon fiber reinforced plastic. Instead of solid rods, it is also possible to employ relatively rigid, hollow tube members.

An additional feature of the carrying device 10 is the provision of first and second handles 32, 34 on each of the sheet sections for manually grasping the respective sheet section. The first handle 32 is adjacent the outer edge 20, 22 of its respective sheet section and the second of the handles is adjacent one of the end edges 24, 26 of its respective sheet section. In the illustrated embodiment, the second handle is adjacent the end edge 24. Each of the handles 32, 34 is preferably a reinforced handle that includes a wide aperture formed in the sheet section. In the case of the first handles 32, the reinforcement can be provided by the adjacent rod 28 or 30 that extends along one side of the wide aperture and that can be grasped by the user in several locations or positions in the opening when the user's hand is inserted through the wide aperture. In the case of the second handles 34, each of these handles can be reinforced by attaching a reinforcing handle member (not shown) to the sheet section. This reinforcing handle member could be a wide loop member that extends completely around the aperture or simply an elongate reinforcing strip that extends along the end edge 24 (or 26) along the outer periphery of the aperture 34. The loop member or reinforcing strip can either be made of strong, rigid plastics material or a softer, durable plastic that is comfortable to grasp.

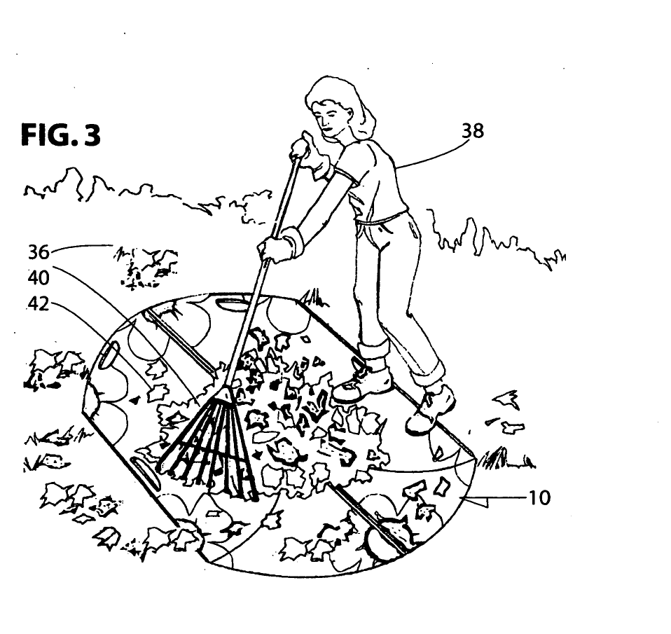

FIG. 3 illustrates how the carrying device 10 of the invention can be used initially in order to collect and dispose of leaves and other yard debris. In FIG. 3, the device 10 has been laid flat on ground surface 36 in the vicinity of the leaves. A person 38 can then use a standard leaf rake 40 to rake leaves 42 onto the upper surface of the carrying device 10. It will be noted here that the carrying device 10 is made of a sturdy material that is sufficiently flexible and pliable that it will lay flat on the ground as shown without difficulty (assuming that the ground itself is relatively flat). Preferably the leaves or debris are raked onto a central area of the carrying device to facilitate subsequent closure of the device around the leaves as explained below.

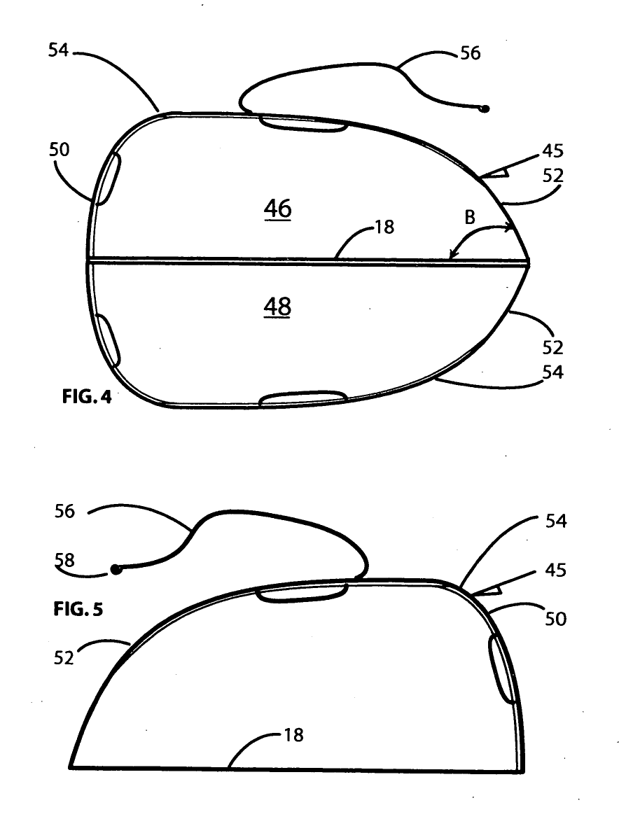

Turning to FIGS. 4 and 5 of the drawings, these drawings show a second embodiment of a leaf crushing and carrying device, this streamlined embodiment being indicated by reference 45. Except as explained hereinafter, the carrying device 45 is similar in its construction to the carrying device 10. Again, the device 45 has two sheet sections 46, 48 but, unlike the sheet sections 14, 16, these sections are not symmetrical about a central transverse axis. As the two sheet sections 46, 48 are identical to each other, it will suffice to describe the shape of one of these two-sheet sections. In particular, the sheet section 46 has an end edge 50 which differs from opposite end edge 52. While both end edges are curved, the end edge 50 extends in a more perpendicular direction to the longitudinal centerline 18. The end edge 52 extends at a smaller angle B to the centerline 18. Both these end edges connect smoothly with an outer edge 54. It will be seen that the end formed by the two end edges 52 is more pointed and this is the pouring end of the carrying device 45. An advantage of the more streamlined, pointed end arrangement is that it allows for better aim when the user is pouring leaves and other refuse into a garbage bin or refuse bag.

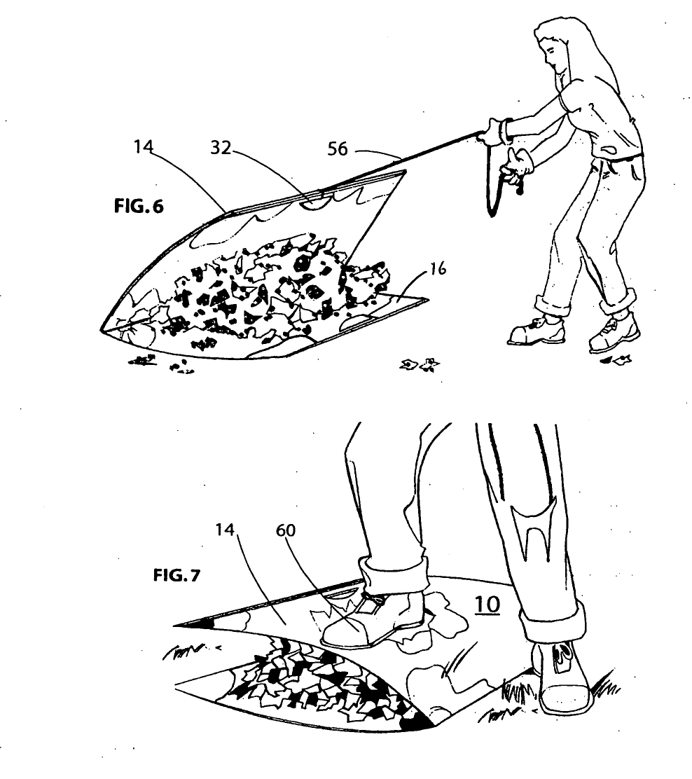

A preferred feature that can be used in either version of the carrying device 10, 54 is an attached rope 56 that can be attached to one side edge of the device. Preferably, the rope should be thick and colored so that it can be easily seen in leaves and debris. In the device of FIG. 1, one end of the rope 56 is connected to the carrying device 10 at outer edge 20 and can, for example, be connected to the rod or tube 28. Preferably the rope 56 is fitted with a knot or handhold 58 at its outer end to allow this outer end to be readily grasped and pulled. The rope is preferably made from nylon or similar flexible plastic material so that it will not rot or deteriorate with time. The manner in which the rope 56 can be used is illustrated in FIG. 6. After the leaves or other debris have been placed on the top surface of the carrying device 10, 45, the user can pull upwardly on the rope in order to initially lift, for example, the first sheet section 14 and then, by pulling horizontally on the rope, the user can bring the sheet section 14 over top of the leaves and debris and over the second sheet section 16. Of course, if no rope 56 is provided, one can use the handle 32 or 34 to lift the first sheet section 14 and to maneuver this sheet section over the second sheet section 16, but this may require more bending and more work on the part of the user.

The next step in the leaf gathering and leaf collection process is illustrated in FIG. 7. As shown in this figure, once the first sheet section 14 has been brought over the leaves piled on the carrying device, trapping the leaves between the two sheet sections, the user can use his or her weight and her foot 60 to apply downward pressure on the top sheet section, thereby crushing the leaves and other debris trapped between the sheet sections. The foot 60 can, of course, be moved around as required in order to crush the leaves and debris as much as possible. This crushing operation may permit additional leaves and debris to be placed on the carrying device, if desired, or the user can then simply employ the carrying device to carry the leaves and debris to a garbage bin, garbage pail, refuse bag or compost bin.

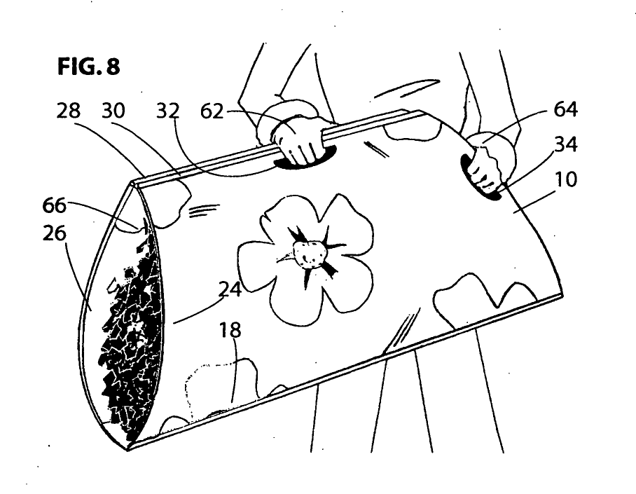

FIG. 8 illustrates how the leaves and debris can be carried using the carrying device 10 or 45. In this view, the two elongate support members 28, 30 have been brought together and are generally parallel. The support members 28, 30 are held together by a user's hand which extends through the two handles 32 (only one of which can be seen in FIG. 8). One end of the carrying device is held closed by the user's other hand 64 which can extend through and grip the two handles 34. A good balance can be achieved with the utilization of the two locations of the combined handle sets. The wide openings provided in both sets of handles allow the user to place his or her hands at one of several locations to achieve a desirable balance for the load and a good pouring position. The end 66 of the carrying device is left open. In order to prevent leaves and debris from falling out of this end, the end 66 can be tilted up while the device and leaves are being carried to the bin, bag or compost pile for disposal. This is easily achieved because of the location of the handles and in particular the ability to tilt the device using the handle set at one end.

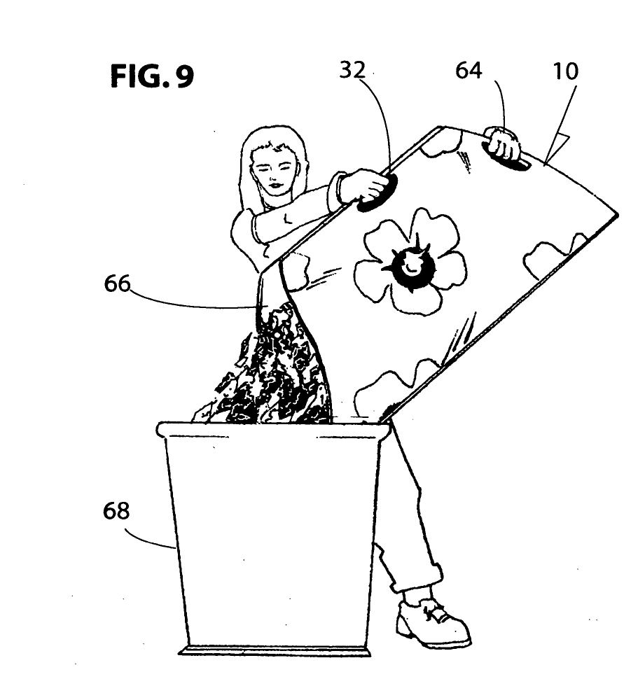

FIG. 9 illustrates the ease with which the present carrying device 10 or 45 can be used to pour leaves and other debris into a garbage pail 68. The user can simply tilt the carrying device so that the open end 66 faces generally downwardly by lifting with the hand 64 that is gripping the closed end of the carrying device. The carrying device is readily balanced during this operation since the handles 32 are located centrally along the length of the device and because of the possible variation in the position where the handles 32 are grasped.

The present carrying device 10, 45 can be constructed from a variety of flexible materials but preferably these materials are tough, long lasting materials. For example, one can use fabric materials with the preferred fabrics being ones made of strong composite fibers or heavy duty industrial tarp. Fabric materials have the advantage of being quite flexible and foldable and the use of such materials can make it fairly easy to store the carrying device when it is not in use by folding it up into a compact unit. Prior to folding, and assuming that the elongate support members 28, 30 have been made detachable or removable, the elongate support members can be removed to permit the device to be folded into a more compact configuration. As an alternative to folding, it is also possible to roll-up the carrying device and possibly store it in a suitable tubular container or to use a combination of these storage methods.

Another preferred material from which the carrying device can be made is polymeric sheeting, carbon fiber filled plastic sheeting or other sturdy polymer composites. The advantages of using such a plastic material is that it can provide a very sturdy, long lasting carrying device and one which can be easy to pour from because of its relative slippery or low friction surface. The preferred materials used to manufacture this carrying device are easily cleanable and impervious to water and mold.

The carrying device 10, 45 can be made in various sizes so that it will be particularly suitable for a chosen job. For example, it can range in size from a relatively small three foot by three foot to a relatively large eight foot by eight foot with the larger sizes being more suitable for light materials and debris such as leaves.

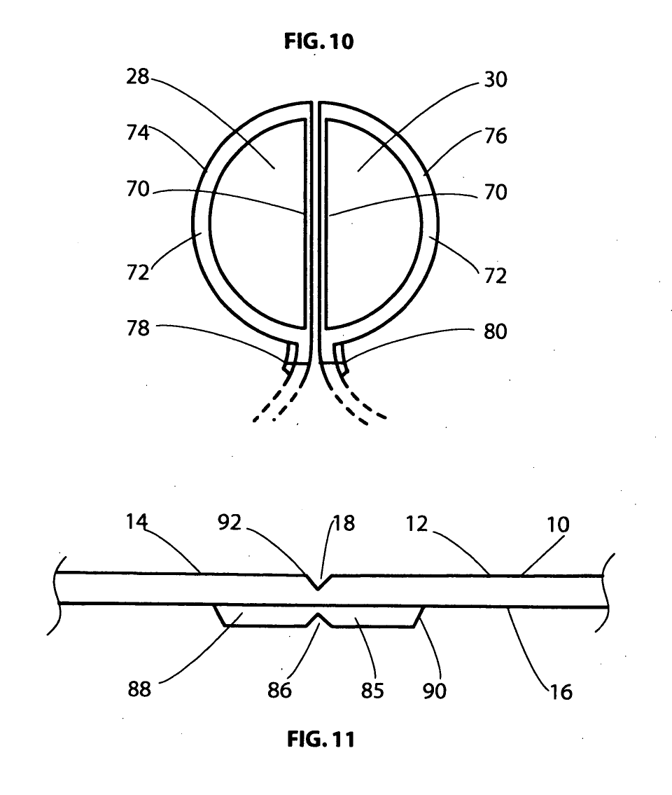

FIG. 10 of the drawings illustrates a preferred construction of the elongate support members or rods 28, 30. In particular, each of these members in transverse cross-section can have a half moon shape that includes a flat side 70 and a semi-cylindrical side 72. When the carrying device is closed up for carrying leaves (as shown in FIG. 8) the two sides 70 can be arranged opposite each other and thus the two elongate members or rods 28, 30 together form an elongate carrying and supporting arrangement with a generally circular cross-section, that is, an arrangement which is relatively easy to grip in the user's hand 62. In order to help hold the two flat sides 70 together, VELCRO™ strips comprising well known hook and loop fastener tapes can be provided along the sides 70 so that these sides can be detachably connected together, if desired.

If fabric material is used for the sheet member 12, then along each outer edge 20, 22 the sheet member can be folded back to form a close fitting, elongate sleeve for the elongate support members 28, 30 as shown in FIG. 10. A folded back strip of the fabric sheeting is shown at 74 and 76. The folded back strip can be secured in place by lines of stitching at 78, 80. The elongate passages formed by the folded back edge strips should be sufficiently long to fully accommodate the respective support members 28, 30 and they should be sufficiently large to permit insertion and easy removal of the elongate support members. If the sheet member is made from a polymer composite or other plastic material, then elongate passageways can be formed in the plastic material to receive elongate support members, if desired. Alternatively, the elongate support members 28, 30 can simply be integrally formed along the outer edges 20, 22 of the plastic sheet member as the sheet member is formed by the extrusion process.

FIG. 11 illustrates how a fold line can be provided along the centerline 18 of the carrying device 10, 45. Shown in transverse cross-section is an elongate, plastic center strip 85 that is permanently bonded to the sheet member 12. Depending upon the plastic used, the bonding of the strip 85 can be carried out in various known ways, including electro-welding, using a suitable adhesive, and heat welding. A longitudinal notch 86 extends down the centerline of the strip 85 from one end to the other, thereby dividing the strip into two strip halves 88, 90. Because the plastic of the center strip 85 is sufficiently bendable and flexible, one of the halves 88, 90 can be pivoted relative to the other half. The sheet member 12 is also preferably formed with an elongate notch 92 disposed on the side of the sheet member located away from the strip 85. The notch 92 is aligned with and parallel to the notch 86 and thus is able to facilitate the bending of one of the sheet sections 14, 16 over the other as described above. It will be appreciated that not only does the center strip 85 reinforce the fold line of the carrying device but it also helps to locate the fold line along the longitudinal centerline 18.

If the sheet member is made of a flexible fabric material which generally will bend and fold more easily than plastic sheeting, a rod or tube member can simply be provided at the centerline 18, this member extending the length of the carrying device and attached to the sheet member by any suitable means. For example, an elongate, opened ended pocket can be formed along the centerline and sized to accommodate the center rod or tube. Alternatively, a rigid or semi-rigid strip, which could be made of metal, wood or plastic, for example, could be attached along the centerline of the sheet member. The elongate rod or strip can be connected by any suitable means such as adhesive or even VELCRO™ strips (which would permit the member to be detached for storage purposes).

It will be appreciated that the described carrying device has a number of advantages for a homeowner or gardener including the following:

a wide variety of refuse can be gathered from any work area and readily disposed of;

the device can be constructed of tough, long lasting materials so as to provide many years of service;

the device can be readily folded up into a compact size or configuration for storage;

use of the device permits the user to remain relatively clean and to avoid coming into contact with wet leaves or debris;

the device can easily be lifted, transported in full state, and used to pour debris into any garbage pail or compost pile;

the device permits certain refuse such as leaves to be compacted prior to being carried to a disposal container or bag;

the device can be made with wide handles that can be easily grasped at one of several locations along the handle and used and that can be reinforced, if desired;

the device can be made sufficiently strong and durable to withstand difficult to handle garbage or debris such as pebbles, wood bits and construction debris;

the device can optionally provide a platform for advertisements by companies such as suppliers to the home and garden industry.

Various modifications and changes can be made to the described carrying devices without departing from the spirit and scope of this invention. Accordingly, all such modifications and changes are intended to be part of the present. invention.

What is claimed:

1. A leaf crushing, carrying and pouring device comprising a flexible, durable sheet member having first and second sheet sections both with inner and outer surfaces, the first and second sections being joined along inner edges of the sheet sections so that one of said sheet sections is foldable over the other sheet section, each sheet section having an outer edge opposite its respective inner edge and two opposite end edges; and
first and second handles on each of said sheet sections for manually grasping the respective sheet section, the first of-said handles being adjacent the outer edge of its respective sheet section and the second of said handles being adjacent one of the end edges of its respective sheet section.

2. A leaf crushing, carrying, and pouring device according to claim 1 wherein said sheet member is made of a strong, reinforced fabric.

3. A leaf crushing, carrying, and pouring device according to claim 2 wherein each of said handles is a reinforced handle including a wide aperture formed in said reinforced fabric.

4. A leaf crushing, carrying, and pouring device according to claim 1 wherein said sheet member is made of substantially flat, extruded polymeric sheeting suitable for placement of advertisements thereon.

5. A leaf crushing, carrying, and pouring device according to claim 1 wherein the handles on each of said sheet sections are wide so as to allow a user's hand location to be adjusted in each handle to permit a good balance of the load for carrying and pouring during use of the device.
